(19) United States
(12) Patent Application Publication
(10) Pub. No.: US 2002/0091988 A1
(43) Pub. Date: Jul. 11, 2002

(54) Method for iterative development and testing of software

(76) Inventor: Paul Murphy, Los Gatos, CA (US)

Correspondence Address: CARR & FERRELL LLP, 2225 EAST BAYSHORE ROAD, SUITE 200, PALO ALTO, CA, 94303, US

(21) Appl. No.: 09/737,700

(22) Filed: Dec. 14, 2000

(51) Int. Cl. G06F 9/44

(52) U.S. Cl. 717/101

(57) ABSTRACT

A method for iterative development and testing of software comprises determining the software functionalities, determining program modules by functionality, defining relationships and dependencies between the program modules, designing and testing each program module, and integrating all of the program modules into a final software product. Each program module or combinations of program modules may be sent to Beta testers.

### BACKGROUND OF THE INVENTION

1. Field of the Invention

This invention relates generally to software development, and relates more particularly to a method for iterative development and testing of software.

2. Description of the Background Art

Software development and testing has typically followed a linear approach. An example of this approach is the so-called “waterfall” development methodology, which emphasizes fully characterizing each level, or phase, of a project before moving on to subsequent levels.

FIG. 1 shows steps of an exemplary waterfall design process. The initial step 110 is to determine the concept of the software product to be produced. The next step 112 is determining the requirements of the product to match the concept. Then, in step 114, the architecture of the software project is determined. In step 116 the actual design and programming take place.

In step 118, the various design activities are integrated and the final product is implemented. Then, in step 120, the product is tested. Once testing is completed, the next step 122 is to install or ship the product to customers. This step may be a Beta testing phase, or may be the actual shipment of product to end users.

Although this waterfall design approach is traditional, it is not without flaws. There is great inflexibility late in the product development, since the architecture has already been determined. Since integration of various subsystems does not take place until relatively late in the process, significant design flaws may not be discovered until the integration step. Late discovery of design flaws may require significant redesign efforts with correspondingly significant extra costs.

The waterfall design approach also does not allow for customer interaction until the end of the design process. Thus, valuable feedback from customers is not received until the product is at or very near completion. Aspects of the product that do not satisfy customers or are inconvenient to use may not be able to be redesigned until after the product's release.

Time to market is very important for software products, but putting fast development first can leave customers with a poorly performing product. Customers are often frustrated when a software product does not perform according to its specifications. Often a manufacturer may need to release numerous software patches before a product will perform correctly.

### SUMMARY OF THE INVENTION

The method of the invention includes determining functionalities of a final software product and assigning the functionalities to program modules. The number of program modules depends upon the number and type of functionalities. The functionalities are assigned to the program modules such that dependencies between the program modules are minimized. Any dependencies between program modules must be simulated in each program module.

Each of the program modules is then designed and tested independently. Two or more program modules may be designed and tested concurrently since dependencies between the program modules have been simulated. When all of the program modules have been designed and tested, they are combined to produce the final product. The final product is then tested and any errors are corrected by redesign. Since the program modules have be tested throughout the development process, errors or problems at this stage will be few. Thus a higher quality product may be produced in less time than required for traditionally developed software products.

Each program module includes at least one design activity. The initial design activity produces an initial design result. The initial design result is tested, and if necessary redesigned, to produce a steady state test environment. Further design activities produce design results that are in turn introduced into the steady state test environment. After each design result is introduced, the behavior of the test environment is observed. If the expected behavior is observed, the design result remains in the test environment and further design activities continue. If the expected behavior is not observed, the most recently added design result is removed from the test environment and redesigned to correct any errors. The redesigned result is then introduced in the test environment and the behavior is again observed.

After all design activities within a program module have been performed and all design results have been tested, a single iterative test is performed. The single iterative test is a final evaluation of the program module. The single iterative test may include Beta testing. Any errors found at this stage are corrected through redesign and further testing.

### BRIEF DESCRIPTION OF THE DRAWINGS

FIG. 1 is a flowchart of method steps for a prior art software development process;

FIG. 2 is a flowchart of method steps for iterative development and testing of software, according to one embodiment of the present invention;

FIG. 3 is a diagram showing program modules in relation to time, according to one embodiment of the invention;

FIG. 4 is a diagram showing a program module, according to one embodiment of the invention; and

FIG. 5 is a flowchart of method steps for performing design activities within a program module, according to one embodiment of the invention.

### DETAILED DESCRIPTION OF THE PREFERRED EMBODIMENT

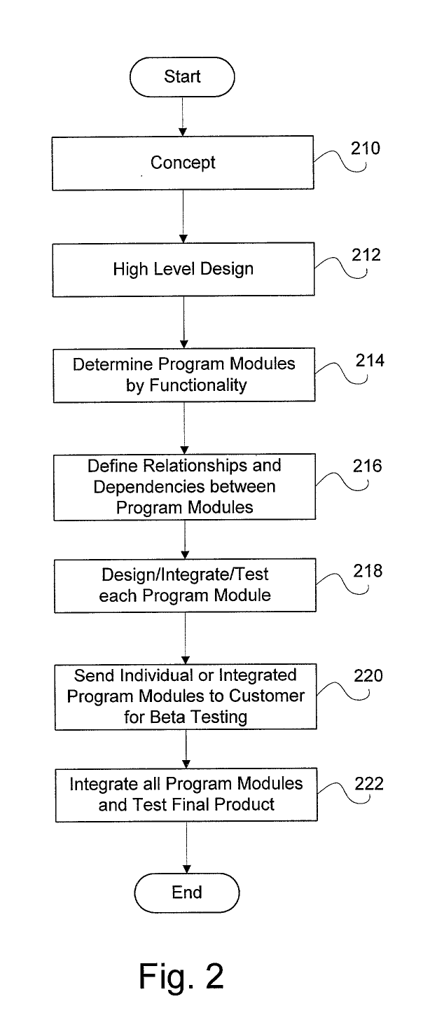

FIG. 2 is a flowchart of method steps for iterative development and testing of software, according to one embodiment of the invention. First, in step 210, the concept of the software product is determined. Often, the overall concept, or purpose, of the software product depends upon both market forces (either real or perceived) and the ability, experience, and knowledge of the development team. For example, the concept may be a telephone network built around the Session Initiation Protocol (SIP).

Next, in step 212, the developers perform the high level design of the product. The high level design includes determining the desired functionalities of the product. The functionalities of the exemplary telephone network may include implementing various features, such as call forwarding and call waiting, and providing various ways for consumers to interact with the telephone service provider, such as an Internet web site and customer service center.

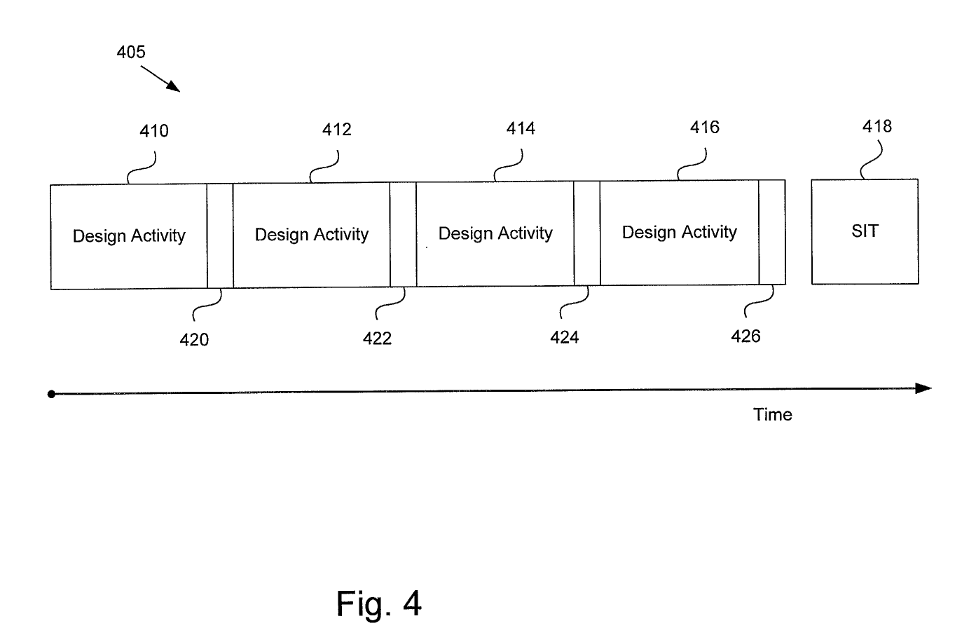

In step 214, the developers assign design activities for producing the software product to program modules. Each program module is determined by functionality, and may include a single functionality or a bundle of related functionalities. The number and size of the program modules depends upon the particular functionalities chosen for the final product. In the exemplary telephone network, the program modules may include a feature engine for the various telephone features, a policy engine to control individual users' accounts, a management engine to control billing, security, and reliability, and a connectivity engine to connect users with the public switched telephone network (PSTN). The structure of a program module is further discussed below in conjunction with FIG. 4.

Next, in step 216, the developers define relationships and dependencies between program modules. These dependencies must be identified prior to performing design activities. For example, some program modules may need results from another program module to perform their functions.

During the design process dependencies between program modules must be simulated so that each program module “sees” its dependencies achieved. For example, when the feature engine is being designed a signal from the policy engine that a user has an active account may need to be simulated to activate a feature.

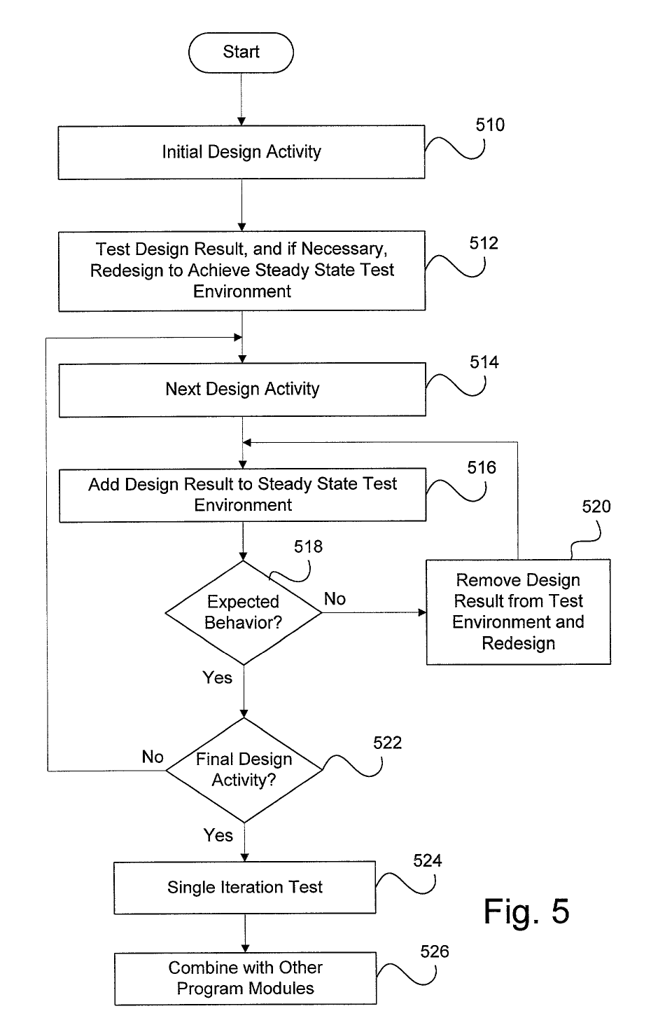

In step 218, the developers then design, integrate, and test each program module. Several, and in some cases all, program modules may be designed, integrated, and tested concurrently, advantageously allowing faster development of the final product. The designing, integrating, and testing of each program module is further discussed below in conjunction with FIGS. 4 and 5.

In step 220, either individual program modules or integrated program modules are optionally sent to a customer or development partner for Beta testing. The decision to Beta test is a function of many factors, including whether a single program module or integrated program modules would be useful to Beta testers. For example, the policy engine integrated with the connectivity engine of the exemplary telephone network may be implemented as a proxy server. By Beta testing program modules discretely, any discovered problems in a program module may be addressed prior to shipping the final product, thus improving the quality of the final product.

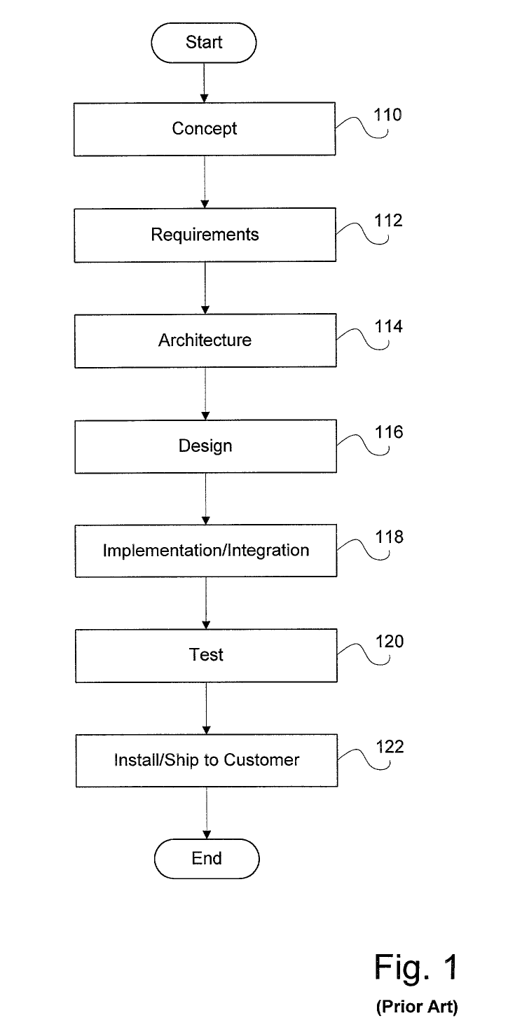

Finally, in step 222, the developers integrate all program modules and test the final product. Since each program module was individually tested in step 218, the final testing period takes less time and has fewer problems to overcome than final testing in the waterfall process of FIG. 1.

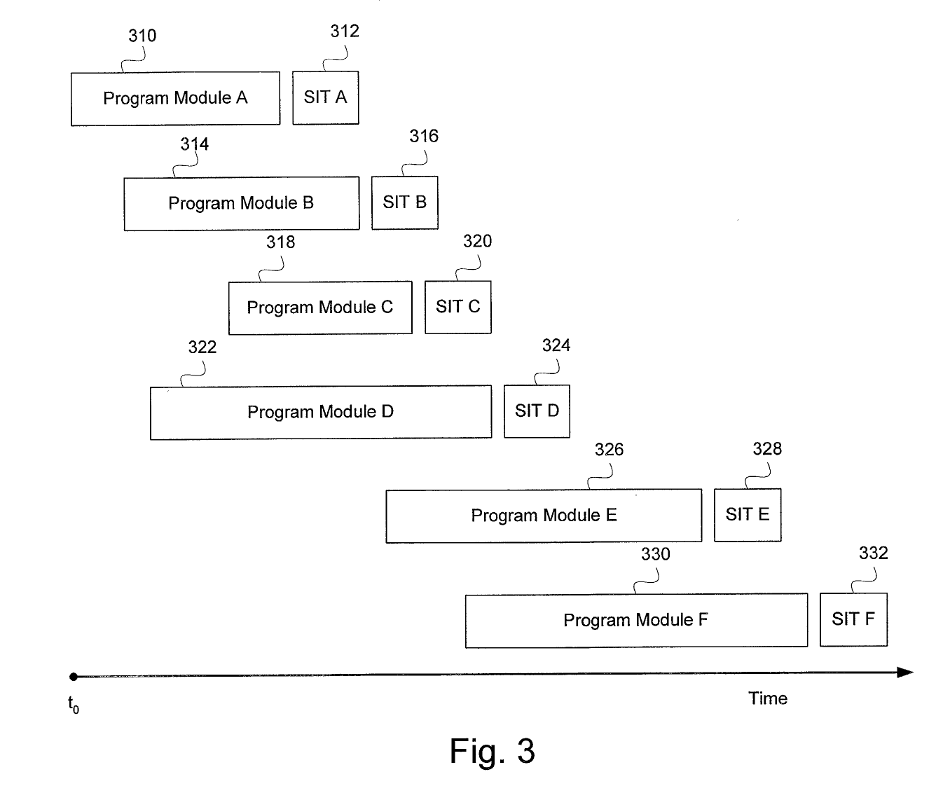

FIG. 3 is a diagram showing program modules in relation to time, according to one embodiment of the invention. Although six program modules are shown, any number of program modules is within the scope of the invention. The number of program modules for a software product typically depends upon the functionalities required for the product. Each program module of FIG. 3 has an associated single iteration test (SIT) module. For example, program module A 310 has an associated SIT A 312.

Each program module may have a different duration, depending on the design activities involved. Since the dependencies between program modules are isolated or simulated, the program modules may be designed and tested in any order. The scheduling of the program modules may depend upon the availability and skills of the programmers who will be designing and testing the software. As shown in FIG. 3, several program modules 310, 314, 318, 322, 326, and 330 may be in progress concurrently. This parallel development allows the final product to be completed more quickly than a product produced using the waterfall process of FIG. 1.

Each SIT module 312, 316, 320, 324, 328, and 332 is a final test of a complete program module. The developers evaluate the performance of the program module, and redesign if necessary to correct any problems. Any problems or errors in the program module likely will be found and remedied before all of the program modules are integrated. Each SIT module may also include customer Beta testing.

FIG. 4 is a diagram showing a program module 405, according to one embodiment of the invention. Each program module includes at least one design activity. Four design activities 410, 412, 414, and 416 are shown in FIG. 4; however, any number of design activities is within the scope of the invention.

After initial design activity 410 is complete, the result is tested during an integration point 420. Any problems identified are remedied by redesigning to achieve a steady state test environment. The next design activity 412 is then performed. During integration point 422, the results of design activity 412 are added to the steady state test environment and its behavior is monitored. Since the test environment was in a steady state, any problems that occur during integration point 422 are due to errors in the results of design activity 412. Thus, only design activity 412 would need to be analyzed and redesigned to find and correct any errors.

The development of program module 405 continues with design activity 414, integration point 424, design activity 416, and integration point 426. The developers then perform the single integration test (SIT) 418. SIT 418 is a formal software product test, which may be implemented as a customer Beta test if program module 405 was developed to contain functionalities of value to customers.

FIG. 5 is a flowchart of method steps for performing design activities within a program module, according to one embodiment of the invention. First, in step 510, software programmers perform the initial design activity of the program module, producing a design result. In step 512, the programmers reach the integration point and test the design result and redesign the initial activity as necessary until the design result is performing correctly. When the initial design result is performing correctly, a steady state test environment has been achieved.

Next, in step 514, the programmers perform the next design activity, producing another design result. In step 516, the programmers test the design result by adding it to the steady state test environment. In step 518, the programmers determine whether the combined design results exhibit the expected behavior. If not, the method moves to step 520 where the last design result is removed from the test environment and redesigned. After redesign, the design result is again added to the steady state test environment.

If in step 518 the combined design results exhibit the expected behavior, the method then moves to step 522. If the current design activity was not the final design activity of the program module, the method continues with step 514. If the current design activity is the final design activity of the program module, then the method moves to step 524.

In step 524, the programmers perform a single iteration test that combines all of the design results of the program module. The combination is then tested until it is performing correctly, thus producing a completed program module. The completed program module may be sent to a customer or development partner for Beta testing. Then, in step 526, the completed program module is combined with other program modules to produce intermediate products for Beta testing or the final software product.

The invention has been explained above with reference to a preferred embodiment. Other embodiments will be apparent to those skilled in the art in light of this disclosure. For example, the present invention may readily be implemented using configurations other than those described in the preferred embodiment above. Additionally, the present invention may effectively be used in conjunction with systems other than the one described above as the preferred embodiment. The present invention, which is limited only by the appended claims, is intended to cover these and other variations upon the preferred embodiment.

What is claimed is:

1. A method for producing a software product, comprising the steps of:
determining functionalities of the software product;
assigning the functionalities to program modules;
designing and testing the program modules independently of each other;
and
integrating the tested program modules to produce the software product.

2. The method of claim 1, wherein the step of designing and testing the program modules includes the steps of:
performing an initial design activity to produce an initial design result;
testing the initial design result to produce a steady state test environment;
if additional design results are necessary, performing a design activity to produce a design result;
introducing the design result into the steady state test environment;
observing the steady state test environment for expected behavior;
if the expected behavior occurs and if additional design results are necessary, performing additional design activities and testing; and
if the expected behavior does not occur, removing the design result from the steady state test environment and redesigning the design result.

3. The method of claim 1, further comprising the step of sending at least one of the tested program modules to Beta testers for further testing.

4. The method of claim 1, wherein the step of designing and testing the program modules comprises designing and testing at least two of the program modules concurrently.

5. The method of claim 1, wherein the step of assigning the functionalities to program modules includes identifying dependencies between the program modules.

6. The method of claim 5, wherein the step of assigning the functionalities to the program modules includes simulating the dependencies between the program modules such that the dependencies appear to be satisfied.

7. The method of claim 1, further comprising the step of sending a tested program module to Beta testers for further testing.

8. The method of claim 1, further comprising the step of integrating at least two tested program modules to produce an intermediate product.

9. The method of claim 8, further comprising the step of sending the intermediate product to Beta testers for further testing.

10. A method for producing a software product, comprising the steps of:
determining at least two groups of design activities;
performing the at least two groups of design activities concurrently to produce at least two design results;
testing the at least two design results; and
combining the at least two design results to produce the software product.
